(19) United States
(12) Patent Application Publication
(10) Pub. No.: US 2008/0120226 A1
(43) Pub. Date: May 22, 2008

(54) Methods and systems for refinancing mortgages

(76) Inventors: Mark Leo Wegmann, Columbia, IL (US); Douglas Allen Gool, Florissant, MO (US)

Correspondence Address: Mark Leo Wegmann, 1550 N. Main Street, Columbia, IL, 62236, US

(21) Appl. No.: 11/602,825

(22) Filed: Nov. 21, 2006

(51) Int. Cl. G06Q 40/00

(52) U.S. Cl. 705/38; 705/35

(57) ABSTRACT

A method and system facilitate management of a payment of a home mortgage loan issued by one of a financial lender and a broker using a computer coupled to a database. The method comprises storing key mortgage loan information associated with a borrower, including data identifying the borrower, an amount of the mortgage loan, a rate of interest payable on the mortgage loan, and the term of the mortgage loan, and inputting market-available refinance data to the computer, wherein the market-available refinance data includes at least one of an interest rate and a loan program. The method also includes automatically comparing the market—available refinance data to the key mortgage loan information associated with the borrower to determine whether the market-available refinance data includes either a reduced finance rate or a shorter term than the borrower's current loan information, and if so, automatically executing a refinance rate lock for the borrower.

### BACKGROUND OF THE INVENTION

This invention relates generally to home mortgage loans and, more particularly, to network-based methods and systems for managing home mortgage loans.

At least some known financing institutions generally engage in the business of issuing loans to borrowers, such as mortgage borrowers. More specifically, at least some known lending institutions provide home loans to debtors in return for periodic time payments at set rates of interest. Generally, the time payments are due at pre-determined payment intervals, such as for example, every month, during the period or the term of the loan. The term of the loan, i.e., a 15 year or 30 year loan, is sometimes defined by the number of time payments to be made, i.e., 180 payments or 360 payments.

Conventionally, home mortgages and other such loans are amortized using a formula which provides that a portion of the payments over the term of the loan are allocated to interest, and the remainder of each payment is allocated to reducing the amount owed, or the principal balance of the loan, and any escrow deposits. The allocation between the portion of each payment allocated towards the interest and the principal varies with each time payment. Generally, most of the payments in the earlier part of the term are allocated to interest, while the smaller amounts allocated to the principal increase as subsequent time payments are made throughout the term of the loan. The reduction in the principal balance by the time payments is known as amortization.

Generally mortgage loans may be classified as fixed-rate or variable-rate. With fixed-rate loans, the interest rate at the time the loan is made determines the rate of interest that is applied for the entire term of the loan. A debtor having a fixed-rate loan may find that after receiving a loan at a fixed rate of interest, interest rates decrease substantially below the fixed rate associated with his loan. To reduce their payment, each debtor naturally prefers to have a loan with the lowest interest rate possible at the time of executing the loan. Over the term of the loan if the prevailing interest rate decreases, such debtors must refinance their loan to take advantage of the decreased interest rates. However, the refinancing a loan can be a timely and costly process to the debtor. For example, when refinancing, debtors must often pay, but are not limited to paying, lender origination fees, underwriting fees, loan processing fees, document preparation fees, and attorney fees. As such, generally refinancing may not be a viable alternative until interest rates have dropped significantly below the initial interest rate associated with the fixed-rate loan.

In contrast, with a variable-rate loan, the interest rate at the time the loan is made may only determine the initial rate of interest. More specifically, with variable-rate loans, the rate of interest of a variable-rate loan is adjusted at pre-determined dates in accordance with a time-varying interest-rate index, such as the rate of interest payable on Treasury Bills. As such, the interest-rate fluctuations may occur several times a year, and as such, may be to the debtor's advantage or detriment depending on whether the variable rate is decreased or increased at the pre-determined dates. As a result, variable-rate loans may not be a viable option to debtors.

### BRIEF DESCRIPTION OF THE INVENTION

In one aspect, a method for managing a payment of a home mortgage loan issued by one of a financial lender and a broker using a computer coupled to a database is provided. The method comprises storing, in the database, key mortgage loan information associated with a borrower, including data identifying the borrower, an amount of the mortgage loan to the borrower, a rate of interest payable on the balance of the mortgage loan, and the term of the mortgage loan, and inputting market-available refinance data to the computer, wherein the market-available refinance data includes at least one of an interest rate and a loan program. The method also includes automatically comparing the market-available refinance data to the key mortgage loan information associated with the borrower to determine whether the market-available refinance data includes at least one of a reduced finance rate and a shorter term than the loan information associated with the borrower, and if the market-available refinance data includes at least one of a reduced finance rate and a shorter term than the loan information associated with the borrower than automatically executing a refinance rate lock to enable a refinance mortgage loan to be executed for the borrower.

In another aspect, a network-based system for managing the payment of mortgage loans issued by a lender to a plurality of borrowers is provided. The system includes a client system comprising a browser, a centralized database for storing information, and a server system configured to be coupled to the client system and the database. The server is configured to store, in the database, key mortgage loan information associated with each borrower, including data identifying each borrower, an amount of the mortgage loan of each borrower, a rate of interest payable on the balance of each mortgage loan for each borrower, and the term of the mortgage loan for each borrower and to receive from an input device coupled to said client system market-available refinance data including at least one of an interest rate and a loan program. The server is also configured to automatically compare the market-available refinance data to the key mortgage loan information associated with each borrower, determine whether the market-available refinance data includes at least one of a reduced finance rate and a shorter term than the loan information associated with each borrower, and automatically execute a refinance rate lock to enable a refinance mortgage loan to be executed for each borrower if the market-available refinance data includes at least one of a reduced finance rate and a shorter term than the loan information associated with that borrower.

### BRIEF DESCRIPTION OF THE DRAWINGS

FIG. 1 is a simplified block diagram of an exemplary system in accordance with one embodiment of the present invention. The system is referred to as an Automatic Refinance System (A.R.S.) system.

FIG. 2 is an expanded block diagram of an exemplary embodiment of a server architecture of a system in accordance with one embodiment of the present invention.

FIG. 3 is a flowchart illustrating an exemplary method of managing the amortization of a loan that may be implemented by the system shown in FIGS. 1 and 2.

### DETAILED DESCRIPTION OF THE INVENTION

Described in detail below are exemplary embodiments of systems and processes that facilitate the management of the amortization of a loan, and that provide mortgage borrowers a means of reducing the total amount of interest which is paid over the life of the mortgage loan, for any given initial interest rate. The system and methods of the present invention also facilitate the buildup of equity as compared to the limited reduction of principal created by not refinancing with more advantageous loans. More specifically, the system and methods of the present invention provide a means by which a borrower may reduce loan principal due to the lender, at a faster rate, than may be possible during the life of an un-refinanced mortgage loan, and as such, provides a means by which the borrower may be able to substantially reduce the amount of interest actually paid during the life of the loan.

In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

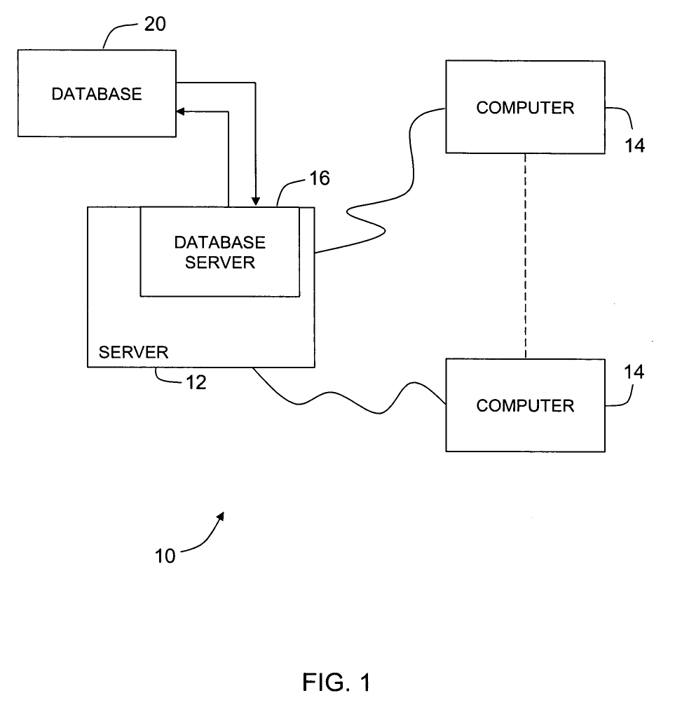

FIG. 1 is a simplified block diagram of an exemplary system 10 in accordance with one embodiment of the present invention. System 10 includes a server system 12, and a plurality of client sub-systems, also referred to as client systems 14, connected to server system 12. System 10 is referred to as a Automatic Refinance System (ARS). Computerized modeling and grouping tools, as described below in more detail, are stored in server system 12 and can be accessed by a requester, such as a loan officer, a finance manager or a broker, at any one of client systems 14. In one embodiment, client systems 14 are computers including a web browser, such that server system 12 is accessible to client systems 14 using the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment, database 20 is stored remotely from server system 12 and may be non-centralized.

System 10 facilitates the management of the re-payment of mortgage loans, and more particularly facilitates control of loan mortgage refinancing. It should be noted the embodiment illustrated in FIG. 1 is exemplary only and that one of ordinary skill in the art should realize that the present invention may be implemented without a significant investment in system architecture design and/or software development.

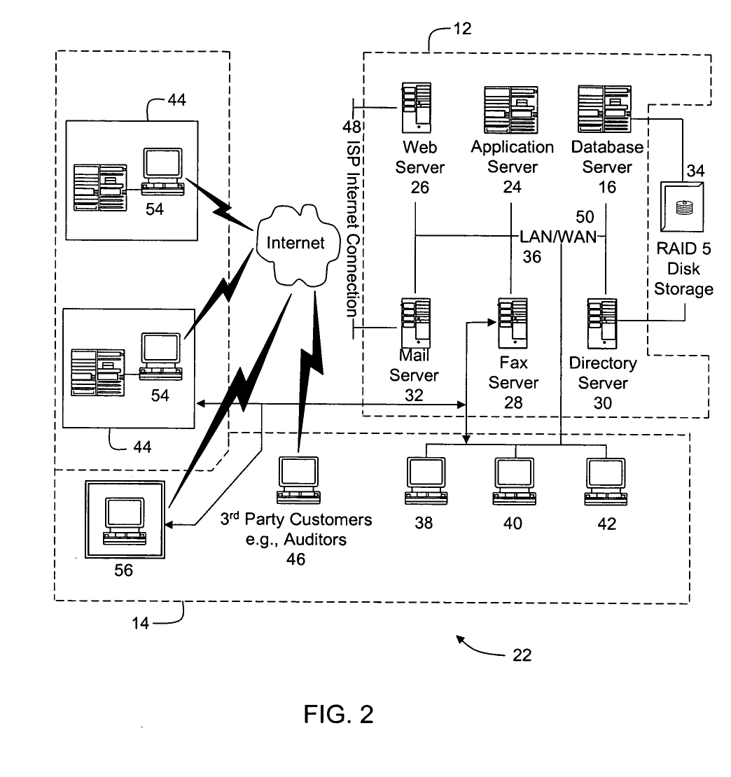

FIG. 2 is an expanded block diagram of an exemplary embodiment of a server architecture of a system 22 in accordance with one embodiment of the present invention. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 using an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

Server system 12 is configured to be communicatively coupled to various individuals, including employees 44 and to third parties, e.g., auditors/customers, 46 using an ISP Internet connection 48. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 50, local area network 36 could be used in place of WAN 50.

In the exemplary embodiment, any authorized individual having a workstation 54 can access system 22. At least one of the client systems includes a manager workstation 56 located at a remote location. Workstations 54 and 56 are personal computers having a web browser. Also, workstations 54 and 56 are configured to communicate with server system 12. Furthermore, fax server 28 communicates with remotely located client systems, including a client system 56 using a telephone link. Fax server 28 is configured to communicate with other client systems 38, 40, and 42 as well.

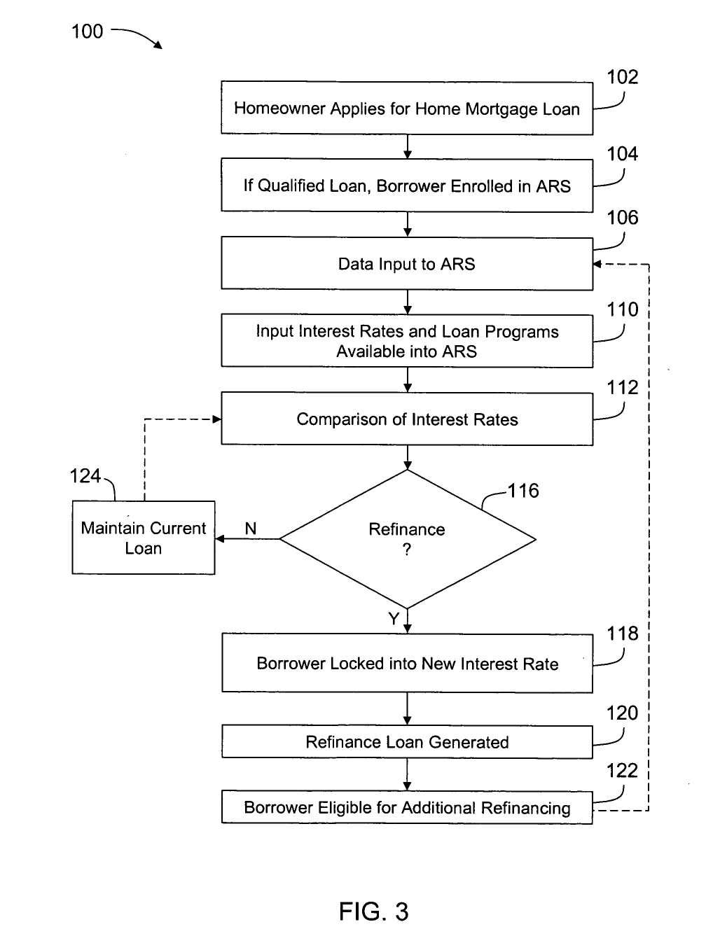

FIG. 3 is a flowchart illustrating an exemplary method 100 of managing the amortization of a loan that may be implemented by system 10 (shown in FIG. 1) or system 22 (shown in FIG. 2). In the exemplary embodiment, system 10 may be utilized by a finance manager associated with a financial lender, a commercial lender, or any other type of lender capable of making mortgage loans to a borrower. System 10 is utilized by the finance manager to manage the refinancing of mortgage loans associated with borrowers that have received mortgage loans from a commercial lender associated with the finance manager. Initially, a home owner or borrower applies for 102 a home mortgage loan from a loan broker, or a loan officer of a commercial lender, associated with the finance manager. The mortgage loan applied for 102 may be a loan for an initial home purchase or may be a loan for a refinance of an existing home mortgage loan. Alternatively, a home owner, borrower, financial lender, and/or broker may enter existing loan information regarding a loan that originated from an alternative funding source.

During the mortgage loan application process, the loan officer of the commercial lender, the broker, and/or the finance manager will outline the benefits of the ARS system, as described in more detail below, to the prospective borrower. More specifically, if the mortgage loan applied for 102 is a fixed rate loan for an amount of at least $100,000, for a one-time nominal lender fee, the borrower is enrolled in the Automatic Refinance System, and remains eligible for the refinancing benefits of ARS 10 for the term of their mortgage, and without paying or incurring any additional fees “out-of-pocket” the time of refinancing. In one embodiment, the lender fee is approximately $400.00 and that fee is split evenly between the commercial lender or broker, and the finance manager.

Upon approval 104 of the mortgage loan, the borrower or home owner, and associated loan information, described in more detail below, are input 106 into the Automated Refinance System 10. Specifically, and using the components identified in FIG. 1 for exemplary purposes, server 12 receives and stores information input 106 regarding the mortgage loan, including, but not limited to, identification information of the borrower, such as, but not limited to, their social security number, their credit report, their contact information, and employment information of the borrower, an amount of the mortgage loan to the borrower, a principal balance of the loan, the fixed interest of the mortgage loan, the term of the mortgage loan, and the date the mortgage loan was executed. Alternatively, information input 106 to server 12 may be any, all, or none of the data described herein. Moreover, information input 106 may include any other data relevant to the borrower. In addition, server 12 also stores data input 116 that is relevant to other required payments associated with the primary mortgage loan, including but not limited to, taxes and/or insurance payments which are paid concurrently with the principal and interest on the mortgage loan and are set aside in escrow. Moreover, server 12 stores information relevant to, but not limited to, the value of the borrower's property, the borrower's home current real estate taxes, and the borrower's home insurance information. In one embodiment, server 12 generates email requests of the borrowers, at pre-determined time intervals, for updated information, such as, but not limited to, employment history updates, and/or updated re al estate tax information. In another embodiment, server 12 periodically schedules home appraisals or other home valuation procedures for borrowers associated with ARS 10.

With a fixed rate mortgage loan, the borrower must make a payment of a fixed amount, each month, with a varying amount being applied first to amortized interest and then the balance of the payment to the remaining principal. For example, for a mortgage loan of $100,000, assuming interest of 7% per year, paid twelve times per year, the monthly mortgage payment would be $665.30. All of such data is input 106 into the Automated Refinance System 10 to enable a finance manager to manage the repayment of the mortgage loan, as described herein. Alternatively, information input 106 to ARS 10 may include other key financial information, in addition to, or in the alternative to, information described herein.

On a continuous basis, the borrower's lender of choice will input 110 approved mortgage loan rates and loan programs into ARS system 10 and more specifically, into server 12. In one embodiment, the loan officer and/or loan broker may input 110 the data into the ARS system 10 through a workstation including a web browser. Server 12 receives the rate data input 110 and stores the data in database server 16. The rates input 110 to server 10 are generally based upon a known index, such as the Federal National Mortgage Association's required net yield on mortgage loans, and, in one embodiment of the invention, the current rates input 110 are determined from the index value by adding a yield spread of at least 0.25 and then rounding the rate to the nearest ⅛th of a point (0.00125). The current rates input may include, but are not limited to including, multiple rates or yields, for different types of mortgage loans, such as a 15-year fixed rate, a 30-year fixed rate, a jumbo fixed rate, and/or an FHA mortgage rate.

The current approved mortgage loan interest rates are automatically compared 112 to the current interest rates of the borrowers that originally received their mortgage loan from that particular lender. More specifically, if the current mortgage loan to a borrower is a given type of mortgage loan which corresponds to a rate input in the table, the Automatic Refinance System is programmed to automatically compare 112 the borrower's current interest rates on their mortgage loans to those of the updated prevailing mortgage loan rates associated with their lender of choice. Because ARS 10 automatically compares the current interest rates of the borrower's mortgage to those interest rates available in the market, neither the borrower nor the commercial lender or broker has the burden of identifying the most advantageous interest rate available from a myriad of interest rates and loan programs that may be available from the various lender options. Moreover, the financial rate lock is substantially simultaneous with ARS 10 such that lost refinancing opportunities to the borrower are facilitated to be reduced.

If the current interest rate is lower than the current interest rate applied to a borrower's mortgage loan, a determination 116 is made of whether refinancing the mortgage loan would either (a) result in net savings of at least a pre-determined amount per month to the borrower, and/or (b) result in shortening the term of loan without appreciably increasing the monthly time payment on the mortgage loan. For example, in one embodiment, ARS 10 determines 116 whether refinancing the mortgage loan would result in net savings of at least $50.00 per month to the borrower. In other embodiments, the finance manager may set the desired savings at a higher or lower dollar threshold within system 10, and/or may adjust or set threshold requirements relevant to the desired term shortening length of the mortgage loan.

If it is determined 116 that refinancing the mortgage loan with the reduced prevailing interest rate would either shorten the term without appreciably increasing the monthly payment, or would result in net savings of at least $50.00 to the borrower, the borrower is automatically locked 118, i.e., a refinance rate lock, into the advertised loan interest rate with the loan officer or broker via server 12 and a refinance mortgage loan may be generated 120 at the reduced interest rate, or at the reduced term. As a result, the mortgage loan of a borrower may be refinanced without any input from the borrower or the loan officer or broker, and without any cost to the borrower. In one embodiment, server 12 is programmed to also generate 120 the refinancing loan documentation.

The commercial lender or broker, and the finance manager receive a fee from the yield spread built into the refinanced interest rate. As such, ARS 10 facilitates enabling a borrower to automatically lock in advantageous refinance loan rates and/or loan programs to enable their home mortgage loans to be refinanced after paying only an initial lender fee at the time of their original mortgage loan. As a result, the borrower does not incur other refinancing expenses that are commonly incurred when mortgage loans are refinanced, including but not limited to, lender origination fees, underwriting fees, loan processing fees, document preparation fees, and attorney fees. Moreover, ARS 10 enables a borrower to be locked 118 into an advantageous interest rate, and refinance 120 their mortgage loans automatically without the borrower's input. In at least some embodiments, the borrower is given the option to select their preference between shortening the mortgage loan and/or reducing the interest rate on the mortgage loan. In at least some embodiments, if the mortgage loan is refinanced to reduce the remaining term of the loan, then the remaining term is reduced without changing the monthly mortgage loan payment.

Server 12 also maintains a history of each mortgage loan generated as associated with each specific borrower. The finance officer may adjust ARS 10 to require the elapse of a minimum number of days, such as ninety days, between subsequent refinances of the same mortgage loan. Specifically, system 10 stores interest rate reduction information and term reduction information (referred to as “performance data”) and key financial performance data in database 20 for each borrower associated with the finance manager. After the pre-determined waiting period has lapsed, the borrower is “reactivated” within ARS 10 and is eligible for additional automatic refinancing opportunities. Specifically, any new data relevant to the borrower and/or the refinanced loan is input 110 to ARS 10, and the borrower is then eligible for refinancing after the pre-determined waiting period has lapsed.

If it is determined 116 that refinancing the mortgage loan with the reduced interest rate would not result in net monthly savings of the pre-determined amount, i.e., at least $50.00 per month, or would not appreciably decrease the loan term without a significant increase in the monthly payment, the current mortgage loan of the borrower is maintained 124. Specifically, in such an instance, the borrower continues to make their regularly scheduled payments until new rates sheets are posted.

As a result, the total interest paid by the borrower over the term of their home mortgage loan is reduced. Moreover, because the borrower is able to automatically lock in an advantageous refinance rate that enables them to refinance their mortgage loan at a reduced term or a reduced interest rate, equity buildup in the borrower's home is facilitated to be increased in comparison to the rate at which equity is generally built up in conventional fixed-rate loan programs. Moreover, ARS 10 facilitates enhanced management of loans to debtors and refinancing options associated with their loans. This management is valuable to lending institutions seeking to efficiently and competitively manage mortgage loans, and is valuable to debtors seeking to adjust the interest rate on their loans without having to go through a complex, costly, or time-consuming refinancing process.

ARS 10 is predominantly web-enabled, which extends its use to all industry professionals connected to the Internet. System 10 defines a custom workflow process for every refinancing transaction originated through ARS 10, which forms a basis for the finance manager to actively monitor the steps and procedures required for a specific loan transaction in order to provide a completion report for the specific mortgage loan. The rules applied to each new mortgage loan application will determine who is permitted or required to perform which services in the loan refinancing process within ARS 10 and defines, in advance, the compensation for services performed. ARS 10 records a history of the actual workflow for each refinancing loan originated within ARS 10.

ARS 10 includes a set of rules appropriate to each mortgage loan transaction, including property and borrower profile, originator's professional guidelines, state and federal regulations and other relevant rules. Moreover, ARS 10 includes protocol that applies to each refinanced mortgage loan to assure that each refinance mortgage loan is originated in accordance with applicable federal and state laws. This will include, making sure that only individuals with authorization are given access to ARS 10 and are permitted to perform services associated with the refinance loan origination process. Moreover, because system 10 accumulates a variety of confidential data, system 10 is programmed with different access levels to control and monitor the security of and access to system 10. Authorization for access is assigned by system administrators on a need to know basis. In one embodiment, access is provided based on job functions. The administration/editing capabilities within system 10 are also restricted to ensure that only authorized individuals have access to modify or edit the data existing in the system. System 10 manages and controls access to system data and information.

The system described herein enables a borrower to be postured to aggressively refinance and pay off their home mortgage loan, without any additional refinancing fees, other than an initial lenders fee. Moreover, because the system is automatic, the borrower can reap the benefits of refinancing at a more advantageous refinance rate without requiring their initiation or the financial lender's or broker's initiation to refinance. As a result, the total interest paid by the borrower over the term of their home mortgage loan is facilitated to be reduced and because the borrower is able to refinance their mortgage loan at a reduced term or a reduced interest rate, equity buildup in the borrower's home is facilitated to be increased in comparison to the rate at which equity is generally built up in conventional fixed-rate loan programs. Moreover, the system enables the enhanced management of lo ans to debtors and refinancing options associated with their loans. This management is valuable to lending institutions seeking to efficiently and competitively manage mortgage loans, and is valuable to debtors seeking to adjust the interest rate on their loans without having to go through a complex, costly, or time-consuming refinancing process. Moreover, this management facilitates reducing lost refinancing opportunities to borrowers.

Exemplary embodiments of an automatic refinancing system are described above in detail. Although the methods and systems described herein for use in refinancing mortgage loans are herein described and illustrated in association with the above-described Automatic Refinancing System, it should be understood that the present invention may be used with any other refinancing system. More specifically, the Automatic Refinancing System described herein is not limited to being used with the architecture or with the specific embodiments described herein, but rather, aspects of the refinancing system and/or the method of refinancing a loan may be utilized independently and separately from other mortgage refinancing methods.

Moreover, based on the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to its exemplary embodiment, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof. Although specific terms are employed herein, they are used in a general and descriptive sense on and not for the purpose of limitation.

While the invention has been described in terms of various specific embodiments, those skilled in the art will recognize that the invention can be practiced with modification within the spirit and scope of the claims.

What is claimed is:

1. A method for managing a payment of a home mortgage loan issued by one of a financial lender and a broker using a computer coupled to a database, said method comprising:
storing, in the database, key mortgage loan information associated with a borrower, including data identifying the borrower, an amount of the mortgage loan to the borrower, a rate of interest payable on the balance of the mortgage loan, and the term of the mortgage loan;
inputting market-available refinance data to the computer, wherein the market-available refinance data includes at least one of an interest rate and a loan program;
automatically comparing the market-available refinance data to the key mortgage loan information associated with the borrower to determine whether the market-available refinance data includes at least one of a reduced finance rate and a shorter term than the loan information associated with the borrower; and
if the market-available refinance data includes at least one of a reduced finance rate and a shorter term than the loan information associated with the borrower than automatically executing a rate lock to enable a refinance mortgage loan to be executed for the borrower.

2. A method in accordance with claim 1 further comprising:
storing refinance mortgage loan information associated with the borrower, including an amount of the refinanced mortgage loan to the borrower, a rate of interest payable on the balance of the refinanced mortgage loan, and the term of the refinanced mortgage loan; and
automatically comparing, after a pre-determined amount of time has lapsed since the refinance mortgage loan was executed, any stored market-available refinance data to the refinance mortgage loan information associated with the borrower to determine whether the market-available refinance data includes at least one of a reduced finance rate and a shorter term than the refinanced loan information associated with the borrower.

3. A method in accordance with claim 1 wherein automatically comparing the market-available refinance data to the key mortgage loan information associated with the borrower comprises determining whether the market-available refinance data will enable the borrower to reduce their loan payments by a pre-determined amount.

4. A method in accordance with claim 1 wherein automatically comparing the market-available refinance data to the key mortgage loan information associated with the borrower comprises determining whether the market-available refinance data will enable the borrower to reduce the term of their loan by a pre-determined amount of time.

5. A method in accordance with claim 1 wherein inputting market-available refinance data to the computer comprises inputting an interest rate associated with at least one of multiple rates for different types of mortgage loans, and multiple yields for different types of mortgage loans.

6. A method in accordance with claim 1 further comprising maintaining a history of key financial performance data associated for the borrower.

7. A method in accordance with claim 1 further comprising:
periodically inputting updated market-available refinance data to the computer, wherein the market-available refinance data includes at least one of an interest rate and a loan program; and
if the mortgage loan associated with the borrower has not been refinanced within a pre-determined amount of time, automatically comparing the updated market-available refinance data to the mortgage loan information associated with the borrower to determine whether the updated market-available refinance data includes at least one of a reduced finance rate and a shorter term than the lo an information associated with the borrower.

8. A method in accordance with claim 1 further comprising periodically inputting updated market-available refinance data to the computer, wherein the market-available refinance data includes at least one of an interest rate and a loan program.

9. A method in accordance with claim 1 further comprising periodically inputting key mortgage loan information associated with a borrower, including an employment history of the borrower, real estate taxes associated with the home of the borrower, and a credit report associated with the borrower.

10. A network-based system for managing the payment of mortgage loans issued by one of a lender and a broker to a plurality of borrowers, said system comprising:
a client system comprising a browser;
a centralized database for storing information; and
a server system configured to be coupled to said client system and said database, said server further configured to:
store, in the database, key mortgage loan information associated with each borrower, including data identifying each borrower, an amount of the mortgage loan of each borrower, a rate of interest payable on the balance of each mortgage loan for each borrower, and the term of the mortgage loan for each borrower;
receive from an input device coupled to said client system market-available refinance data including at least one of an interest rate and a loan program;
automatically compare the market-available refinance data to the key mortgage loan information associated with each borrower;
determine whether the market-available refinance data includes at least one of a reduced finance rate and a shorter term than the loan information associated with each borrower; and
automatically execute a refinance rate lock to enable a refinance mortgage loan to be executed for each borrower if the market-available refinance data includes at least one of a reduced finance rate and a shorter term than the loan information associated with that borrower.

11. A network-based system in accordance with claim 10 wherein said system facilitates one of reducing an interest rate associated with the mortgage loan of each borrower, and reducing a loan term associated with the mortgage loan of each borrower.

12. A network-based system in accordance with claim 10 wherein said server is further configured to maintain a history of key financial performance data associated for each borrower.

13. A network-based system in accordance with claim 10 wherein said server is further configured to store refinance mortgage loan information associated with each borrower refinancing their mortgage loan, wherein such information includes an amount of the refinanced mortgage loan to each borrower, a rate of interest payable on the balance of the refinanced mortgage loan for each borrower, and the term of the refinanced mortgage loan for each borrower

14. A network-based system in accordance with claim 13 wherein said server is further configured to:
automatically compare, after a pre-determined amount of time has lapsed since a refinance mortgage loan was executed for each borrower that refinanced their mortgage loan, any stored market-available refinance data to the refinance mortgage loan information associated with each borrower that refinanced their mortgage loan; and
determine whether the market-available refinance data includes at least one of a reduced finance rate and a shorter term than the refinanced loan information associated with each borrower.

15. A network-based system in accordance with claim 10 wherein to automatically compare the market-available refinance data to the key mortgage loan information associated with each borrower, said server is further configured to determine whether the market-available refinance data will enable the borrower to reduce their loan payments by a pre-determined amount.

16. A network-based system in accordance with claim 10 wherein to automatically compare the market-available refinance data to the key mortgage loan information associated with each borrower, said server is further configured to determine whether the market-available refinance data will enable the borrower to reduce their loan term by a pre-determined amount of term.

17. A network-based system in accordance with claim 10 wherein said server is further configured to receive from an input device coupled to said client system a plurality of interest rates and yields for different types of mortgage loans.

18. A network-based system in accordance with claim 10 wherein said server is further configured to receive from an input device updated market-available refinance data to the computer, wherein the market-available refinance data includes at least one of an interest rate and a loan program.
